(19) United States
(12) Patent Application Publication
(10) Pub. No.: US 2026/0186684 A1
(43) Pub. Date: Jul. 2, 2026

(54) INCREASED MEMORY RELIABILITY VIA REDUNDANCY

(71) Applicant: Micron Technology, Inc., Boise, ID (US)

(72) Inventors: Anthony D. Veches, Boise, ID (US); Scott E. Schaefer, Boise, ID (US)

(21) Appl. No.: 19/430,154

(22) Filed: Dec. 22, 2025

Related U.S. Application Data
(60) Provisional application No. 63/740,253, filed on Dec. 30, 2024.

(51) Int. Cl. G06F 3/06

(52) U.S. Cl. CPC G06F 3/065; G06F 3/0619; G06F 3/0659; G06F 3/0673

(57) ABSTRACT

Methods, systems, and devices for increased memory reliability via redundancy are described. The memory system may receive a write command associated with data to be written to the memory system and write the data to a first portion of the memory system and a copy of the data to a second portion of the memory system based on the write command. After writing the data and the copy of the data, the memory system may receive a read command for the data and read the data from the first portion and the copy of the data from the second portion based on the read command. After reading the data and the copy of the data, the memory system may perform an error control operation on the data and the copy of the data and transmit the data or the copy of the data based on performing the error control operation.

### CROSS REFERENCE

The present Application for Patent claims priority to U.S. Patent Application No. 63/740,253 by Veches et al., entitled “INCREASED MEMORY RELIABILITY VIA REDUNDANCY,” filed Dec. 30, 2024, which is assigned to the assignee hereof, and which is expressly incorporated by reference in its entirety herein.

### TECHNICAL FIELD

The following relates to one or more systems for memory, including increased memory reliability via redundancy.

### BACKGROUND

Memory devices are used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored by the memory cell. To store information, a memory device may write (e.g., program, set, assign) states to the memory cells. To access stored information, a memory device may read (e.g., sense, detect, retrieve, determine) states from the memory cells.

### BRIEF DESCRIPTION OF THE DRAWINGS

FIG. 1 shows an example of a system that supports increased memory reliability via redundancy in accordance with examples as disclosed herein.

FIG. 2 shows an example of an architecture that supports increased memory reliability via redundancy in accordance with examples as disclosed herein.

FIG. 3 shows an example of a system that supports increased memory reliability via redundancy in accordance with examples as disclosed herein.

FIG. 4 shows an example of a process flow that supports increased memory reliability via redundancy in accordance with examples as disclosed herein.

FIG. 5 shows a block diagram of a memory system that supports increased memory reliability via redundancy in accordance with examples as disclosed herein.

FIG. 6 shows a flowchart illustrating a method or methods that support increased memory reliability via redundancy in accordance with examples as disclosed herein.

### DETAILED DESCRIPTION

In some examples, a memory system may receive a first command (e.g., a write command) to write data to a portion of a memory device of the memory system. Upon receiving the first command, the memory system may store data to the portion of the memory device. After storing the data to the portion of the memory system, the memory system may receive a second command (e.g., a read command) for the data. Upon receiving the second command, the memory system may retrieve the data from the portion of the memory device and perform an error control operation on the data. If the memory system detects an uncorrectable error in the data based on performing the error control operation, the memory system may discard the data and, in some examples, transmit an error message to the host system and may not transmit the data to the host system. Accordingly, the memory system may experience relatively high data loss and low reliability. A memory system configured to send a backup copy of the data to host system in response to detecting the uncorrectable error in the data, as opposed to sending the error message, to decrease data loss and increase reliability may be desirable.

As described herein, the memory system may receive a write command associated with data to be written to the memory system. In response to the write command, the memory system may write data to a first portion of the memory system (e.g., a first memory bank of a memory device of the memory system) and a copy of the data to a second portion of the memory system (e.g., a second memory bank of the memory device). After writing the data and the copy of the data, the memory system may receive a read command for the data and perform an error control operation on both the data and the copy of the data (e.g., after reading the data and the copy of the data). Upon performing the error control operation, the memory system may transmit one of the data or the copy of the data to the host system. In some examples, the memory system may transmit the copy of the data to the host system in response to detecting an error in the data while performing the error control operation. Using the methods as described herein, the memory system may increase the reliability of the data stored at the memory system because, even if the memory system detects an uncorrectable error in the data, the memory system may send the copy of the data to the host system.

In addition to applicability in memory systems as described herein, techniques for increased memory reliability via redundancy may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by increasing reliability of data stored at a memory system, which may decrease processing or latency times, improve response times, or otherwise improve user experience, among other benefits.

Features of the disclosure are illustrated and described in the context of systems and architectures. Features of the disclosure are further illustrated and described in the context of an architecture, a process flow, and a flowchart.

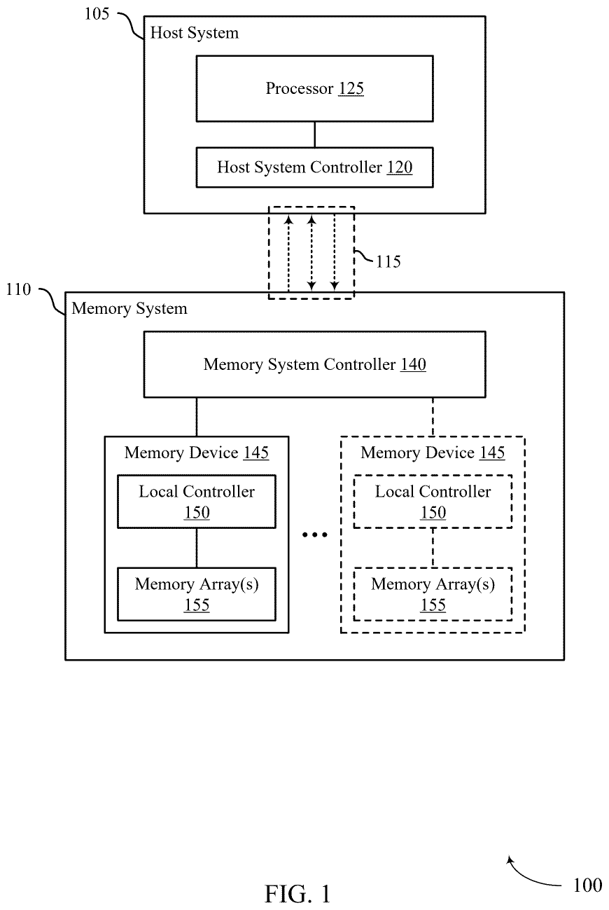

FIG. 1 shows an example of a system 100 that supports increased memory reliability via redundancy in accordance with examples as disclosed herein. The system 100 may include portions of an electronic device, such as a computing device, a mobile computing device, a wireless communications device, a graphics processing device, a vehicle, a smartphone, a wearable device, an internet-connected device, a vehicle controller, a system on a chip (SoC), or other stationary or portable electronic system, among other examples. The system 100 includes a host system 105, a memory system 110, and one or more channels 115 coupling the host system 105 with the memory system 110 (e.g., to support a communicative coupling). The system 100 may include any quantity of one or more memory systems 110 coupled with the host system 105.

A host system 105 may include one or more components (e.g., circuitry, processing circuitry, application processing circuitry, one or more processing components) that use memory to execute processes (e.g., applications, functions, computations), any one or more of which may be referred to as or be included in a processor 125 (e.g., an application processor). A processor 125 may include at least one of one or more processing elements that may be co-located or distributed, including a general-purpose processor, a digital signal processor (DSP), an application-specific integrated circuit (ASIC), a field-programmable gate array (FPGA) or other programmable logic device, a controller, discrete gate or transistor logic, one or more discrete hardware components, or a combination thereof. A processor 125 may be an example of a central processing unit (CPU), a graphics processing unit (GPU), a general-purpose GPU (GPGPU), or an SoC or a component thereof, among other examples.

A host system 105 may also include at least one of one or more components (e.g., circuitry, logic, instructions) that implement the functions of an external memory controller (e.g., a host system memory controller), which may be referred to as or be included in a host system controller 120. For example, a host system controller 120 may issue commands or other signaling for operating a memory system 110, such as write commands, read commands, configuration signaling or other operational signaling. In some examples, a host system controller 120, or associated functions described herein, may be implemented by or be part of a processor 125. For example, a host system controller 120 may be hardware, instructions (e.g., software, firmware), or a combination thereof implemented by a processor 125 or other component of a host system 105. In various examples, a host system 105 or a host system controller 120 may be referred to as a host.

A memory system 110 provides physical memory locations (e.g., addresses) that may be used or referenced by the system 100. A memory system 110 may include a memory system controller 140 and one or more memory devices 145 (e.g., memory packages, memory dies, portions of a memory die) operable to store data. A memory system 110 may be configurable for operations with different types of host systems 105 and may respond to commands from the host system 105 (e.g., from a host system controller 120). For example, a memory system 110 (e.g., a memory system controller 140) may receive a write command indicating that the memory system 110 is to store data received from a host system 105, or receive a read command indicating that the memory system 110 is to provide data stored in a memory device 145 to a host system 105, or receive a refresh command indicating that the memory system 110 is to refresh data stored in a memory device 145, among other types of commands and operations.

A memory system controller 140 may include at least one of one or more components (e.g., circuitry, logic, instructions) operable to control operations of a memory system 110. A memory system controller 140 may include hardware or instructions that support the memory system 110 performing various operations, and may be operable to receive, transmit, or respond to commands, data, or control information related to operations of the memory system 110. A memory system controller 140 may be operable to communicate with one or more of a host system controller 120, one or more memory devices 145, or a processor 125. In some examples, a memory system controller 140 may control operations of the memory system 110 in cooperation with a host system controller 120, a local controller 150 of a memory device 145, or any combination thereof. Although the example of memory system controller 140 is illustrated as a separate component of the memory system 110, in some examples, aspects of the functionality of the memory system 110 may be implemented by a processor 125, a host system controller 120, at least one of one or more local controllers 150, or any combination thereof.

Each memory device 145 may include a local controller 150 (e.g., a logic controller, an interface controller, one or more processors) and one or more memory arrays 155. A memory array 155 may be a collection of memory cells (e.g., a two-dimensional array, a three-dimensional array, an array of one or more semiconductor components), with each memory cell being operable to store data (e.g., as one or more stored bits). Each memory array 155 may include memory cells of various architectures, such as random access memory (RAM) cells, dynamic RAM (DRAM) cells, synchronous dynamic RAM (SDRAM) cells, static RAM (SRAM) cells, ferroelectric RAM (FeRAM) cells, magnetic RAM (MRAM) cells, resistive RAM (RRAM) cells, phase change memory (PCM) cells, chalcogenide memory cells, not-or (NOR) memory cells, and not-and (NAND) memory cells, or any combination thereof.

A local controller 150 may include at least one of one or more components (e.g., circuitry, logic, instructions) operable to control operations of a memory device 145. In some examples, a local controller 150 may be operable to communicate (e.g., receive or transmit data or commands or both) with a memory system controller 140. In some examples, a memory system 110 may not include a memory system controller 140, and a local controller 150 or a host system controller 120 may perform functions of a memory system controller 140 described herein. In some examples, a local controller 150, or a memory system controller 140, or both may include decoding components operable for accessing addresses of a memory array 155, sense components for sensing states of memory cells of a memory array 155, write components for writing states to memory cells of a memory array 155, or various other components operable for supporting described operations of a memory system 110.

A host system 105 (e.g., a host system controller 120) and a memory system 110 (e.g., a memory system controller 140) may communicate information (e.g., data, commands, control information, configuration information, timing information) using one or more channels 115. Each channel 115 may be an example of a transmission medium that carries information, and each channel 115 may include one or more signal paths (e.g., a transmission medium, an electrical conductor, a conductive path) between terminals (e.g., nodes, pins, contacts) associated with the components of the system 100. A terminal may be an example of a conductive input or output point of a device of the system 100, and a terminal may be operable as part of a channel 115. In some implementations, at least the channels 115 between a host system 105 and a memory system 110 may include or be referred to as a host interface (e.g., a physical host interface). To support communications over channels 115, a host system 105 (e.g., a host system controller 120) and a memory system 110 (e.g., a memory system controller 140) may include receivers (e.g., latches) for receiving signals, transmitters (e.g., drivers) for transmitting signals, decoders for decoding or demodulating received signals, or encoders for encoding or modulating signals to be transmitted, among other components that support signaling over channels 115, which may be included in a respective interface portion of the respective system.

A channel 115 may be dedicated to communicating one or more types of information, and channels 115 may include unidirectional channels, bidirectional channels, or both. For example, the channels 115 may include one or more command/address channels, one or more clock signal channels, one or more data channels, among other channels or combinations thereof. In some examples, a channel 115 may be configured to provide power from one system to another (e.g., from the host system 105 to the memory system 110, in accordance with a regulated voltage). In some examples, at least a subset of channels 115 may be configured in accordance with a protocol (e.g., a logical protocol, a communications protocol, an operational protocol, an industry standard), which may support configured operations of and interactions between a host system 105 and a memory system 110.

In some examples, the memory system 110 may implement redundancy techniques to increase reliability of the memory system 110. For example, the memory system 110 may receive, from the host system 105, a write command associated with data to be written to the memory system 110. In response to the write command, the memory system 110 may write the data to a first portion of the memory system 110 and a copy of the data to a second portion of the memory system 110. Further, the memory system 110 may receive, from the host system 105, a read command for the data after writing the data and the copy of the data and perform an error control operation on the data and the copy of the data after reading the data and the copy of the data. Upon performing the error control operation, the memory system 110 may transmit the data or the copy of the data to the host system 105. Using the methods as described herein, the memory system 110 may increase reliability of data stored at the memory system 110.

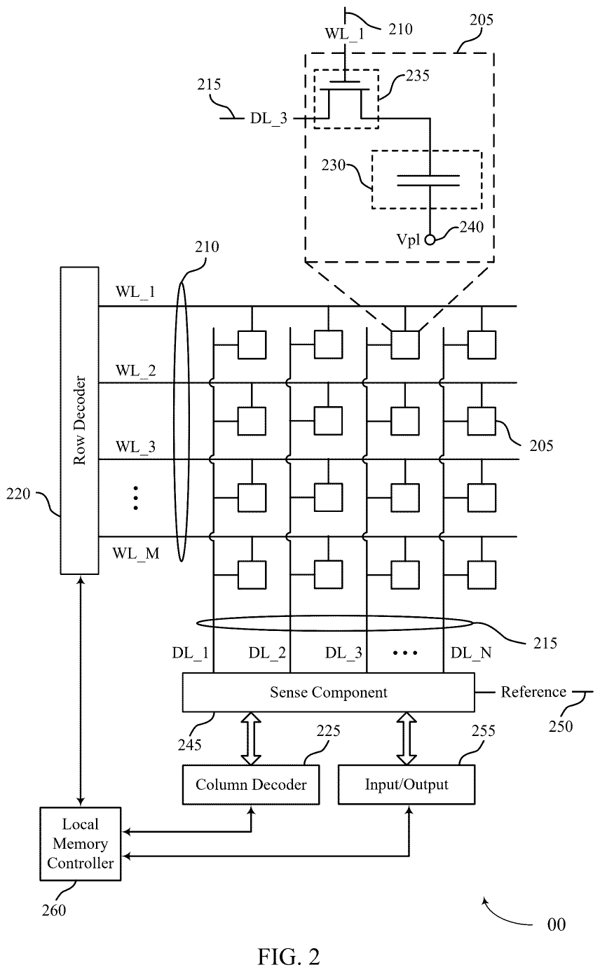

FIG. 2 illustrates an example of an architecture 200 (e.g., a memory architecture) that supports increased memory reliability via redundancy in accordance with examples as disclosed herein. The architecture 200 may be implemented in a memory system 110 or one or more components thereof (e.g., memory device 145). Aspects of the architecture 200 may be referred to as or implemented in a semiconductor component, such as a memory die.

The architecture 200 includes memory cells 205 that are programmable to store information. In some examples, a memory cell 205 may be operable to store one bit of information at a time (e.g., a logic 0 or a logic 1). In some examples, a memory cell 205 (e.g., a multi-level memory cell) may be operable to store more than one bit of information at a time (e.g., a logic 00, logic 01, logic 10, a logic 11). Memory cells 205 may be arranged in an array, such as in a memory array 155.

In the example of architecture 200, a memory cell 205 may include a storage component, such as capacitor 230, and a selection component 235 (e.g., a cell selection component, a transistor). A capacitor 230 may be a dielectric capacitor or a ferroelectric capacitor. A node of the capacitor 230 may be coupled with a voltage source 240, which may be a cell plate reference voltage, such as Vpl, or may be a ground voltage, such as Vss. A charge stored by a memory cell 205 (e.g., by a capacitor 230) may be representative of a programmed state. Other memory architectures that support the techniques described herein may implement different types or arrangements of storage components and associated circuitry (e.g., with or without a selection component).

The architecture 200 may include various arrangements of access lines, such as word lines 210 and digit lines 215. An access line may be a conductive line that is coupled with a memory cell 205, and may be used to perform access operations on the memory cell 205. Word lines 210 may be referred to as row lines, and digit lines 215 may be referred to as column lines or bit lines, among other nomenclature. Memory cells 205 may be positioned at intersections of access lines, and an intersection may be referred to as an address of a memory cell 205.

In some architectures, a word line 210 may be coupled with a gate of a selection component 235 of a memory cell 205, and may be operable to control (e.g., switch, modulate a conductivity of) the selection component 235. A digit line 215 may be operable to couple a memory cell 205 with a sense component 245. In some architectures, a memory cell 205 (e.g., a capacitor 230) may be coupled with a digit line 215 during portions of an access operation. For example, a word line 210 and a selection component 235 of a memory cell 205 may be operable to couple or isolate a capacitor 230 of the memory cell 205 with a digit line 215.

Operations such as reading and writing may be performed on memory cells 205 by activating (e.g., applying a voltage to) access lines such as a word line 210 or a digit line 215. Accessing the memory cells 205 may be controlled through a row decoder 220, or a column decoder 225, or a combination thereof. For example, a row decoder 220 may receive a row address (e.g., from a local memory controller 260) and activate a word line 210 based on a received row address, and a column decoder 225 may receive a column address and activate a digit line 215 based on a received column address. Selecting or deselecting a memory cell 205 may include activating or deactivating a selection component 235 using a word line 210. For example, a capacitor 230 may be isolated from a digit line 215 when the selection component 235 is deactivated, and the capacitor 230 may be coupled with the digit line 215 when the selection component 235 is activated.

A sense component 245 may be operable to detect a state (e.g., a charge) stored by a capacitor 230 of a memory cell 205 and determine a logic state of the memory cell 205 based on the stored state. A sense component 245 may include one or more sense amplifiers to amplify or otherwise convert a signal resulting from accessing the memory cell 205. The sense component 245 may compare a signal detected from the memory cell 205 with a reference 250 (e.g., a reference voltage). The detected logic state of the memory cell 205 may be provided as an output of the sense component 245 (e.g., via an input/output 255), and may indicate the detected logic state to another component of a memory system 110 that implements the architecture 200.

The local memory controller 260 may control the accessing of memory cells 205 through the various components (e.g., a row decoder 220, a column decoder 225, a sense component 245), and may be an example of or otherwise included in a local controller 150, or a memory system controller 140, or both. In some examples, one or more of a row decoder 220, a column decoder 225, and a sense component 245 may be co-located with or included in the local memory controller 260. The local memory controller 260 may be operable to receive commands or data from one or more different controllers (e.g., a host system controller 120, a memory system controller 140), translate the commands or the data into information that can be used by the architecture 200, initiate or control one or more operations of the architecture 200, and communicate data from the architecture 200 to a host (e.g., a host system 105) based on performing the one or more operations.

The local memory controller 260 may be operable to perform one or more access operations on one or more memory cells 205 of the architecture 200. Examples of an access operation may include a write operation, a read operation, a refresh operation, a precharge operation, or an activate operation, among others. In some examples, an access operation may be performed by or otherwise coordinated by the local memory controller 260 in response to one or more access commands (e.g., from a host system 105). The local memory controller 260 may be operable to perform other access operations not listed here or other operations related to the operating of the architecture 200 that are not directly related to accessing the memory cells 205.

As described herein, the memory system may store data at a first portion of a memory device of the memory system and a copy of the data to a second portion of the memory device based on a write command associated with the data. In some examples, prior to storing the data and the copy of the data to the memory system, the memory system may perform an error control operation on both the data and the copy of the data using one or more error control components (e.g., one or more ECC engines). In some examples, the first portion of the memory device and the second portion of the memory device may share an error control component and other components (e.g., the local memory controller 260, the sense component 245, the row decoder 220, etc.).

In other examples, the first portion of the memory device and the second portion of the memory device may not share the error control component. In such examples, the memory device may include a first error control component for the first portion of the memory device and a second error control component for the second portion of the memory device. Using the methods and components as described herein, the memory system may increase the reliability of the data stored at the memory system because, even if the memory system detects an uncorrectable error in the data, the memory system may relay the data to the host system by sending the copy of the data to the host system.

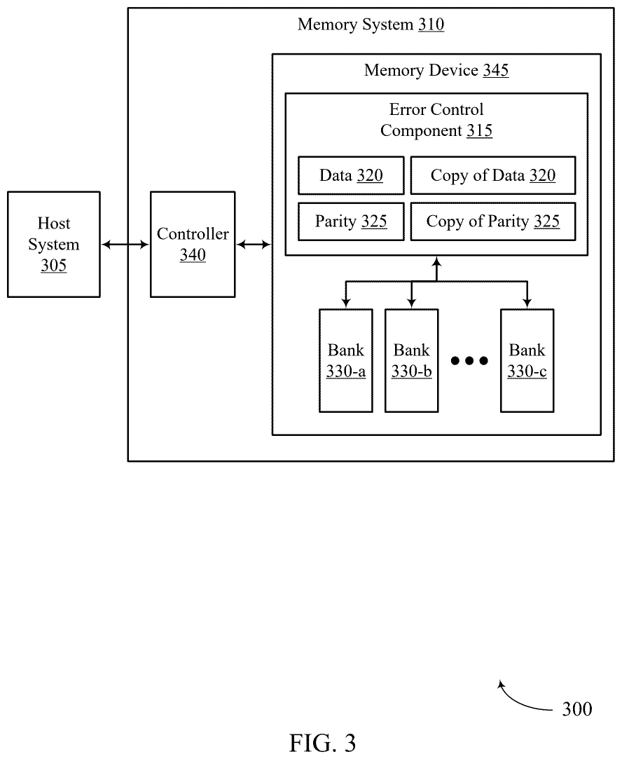

FIG. 3 shows an example of a system 300 that supports increased memory reliability via redundancy in accordance with examples as disclosed herein. In some examples, the system 300 may implement aspects of the system 100. For example, the system 300 may include a host system 305, a memory system 310, a controller 340, a memory device 345, and a bank 330 which may be examples of the host system 105, the memory system 110, the memory system controller 140, the memory device 145, and a memory array 155, respectively, as described with reference to FIG. 1.

In some examples, the memory system 310 may support error correction or error detection techniques. For example, during a write operation, the host system 305 may transmit a write command to the controller 340 of the memory system 310 to write data 320 to the memory device 345. Upon receiving the write command, the controller 340 may transmit the data 320 to the error control component 315 of the memory device 345. The error control component 315 may utilize the data 320 to generate parity 325 (e.g., one or more parity bits) associated with the data 320 and transmit the data 320 and the parity 325 for storage at one or more banks 330 of the memory device 345.

During a read operation for the data 320, the host system 305 may transmit read command for the data 320 to the controller 340 of the memory system 310 and the controller 340 may forward the read command for the data 320 to the memory device 345. In response to read command for the data 320, the error control component 315 of the memory device 345 may retrieve the data 320 and the parity 325 from the one or more banks 330. Additionally, the error control component 315 may generate second parity 325 based on the data 320 retrieved from the one or more banks 330 and compare the second parity 325 to the parity 325.

If the parity 325 and the second parity 325 match, the error control component 315 may determine that the data 320 includes zero errors (e.g., the data is error-free) and the memory device 345 may transmit the data 320 to the controller 340 such that the controller 340 may communicate the data 320 to the host system 305. Alternatively, if the parity 325 and the second parity 325 do not match, the error control component 315 may determine that the data 320 includes one or more errors. If the data 320 includes a correctable error (e.g., a single bit error (SBE)), the error control component 315 may correct the one or more errors and the memory device 345 may transmit the data 320 to the controller 340 such that the controller 340 may communicate the data 320 to the host system 305. Alternatively, if the data 320 includes an uncorrectable error (e.g., a double bit error (DBE), a multi-bit error (MBE)), the error control component 315 may not correct the one or more errors and, in some instances, the memory system 310 may transmit an error message associated with the data 320 to the host system 305.

As described herein, to increase the reliability of the data 320, the memory system 310 may implement redundancy techniques. For example, the host system 305 may transmit a write command to the controller 340 of the memory system 310 indicating for the memory system 310 to write the data 320 to a bank 330-a of the memory device 345. Upon receiving the write command, the controller 340 may forward the write command and the data 320 to the memory device 345. In response to receiving the write command and the data 320, the memory device 345 may write the data 320 to a first portion of the memory device 345 and a copy of the data 320 to a second portion of the memory device 345. For example, the memory device 345 may write the data to the bank 330-a and the copy of the data 320 to the bank 330-b. Alternatively, the memory device 345 may write the data 320 to a first portion of the bank 330-a and the copy of the data 320 to a second portion of the bank 330-a.

In some examples, the memory device 345 may store more than one copy of the data 320 to the memory device 345. For example, upon receiving the write command, the memory device 345 may store a second copy of the data 320 to a third portion of the memory device 345 (e.g., a bank 330-c). In some instances, the memory device 345 may store any quantity of copies of the data 320 (e.g., one or more copies of the data 320) to the memory device 345 in response to a write command associated with the data 320.

During a read operation for the data 320, the host system 305 may transmit a read command for the data 320 to the controller 340 of the memory system 310 and the controller 340 may forward (e.g., transmit, relay) the read command for the data 320 to the memory device 345. In response to the read command, the memory device 345 may retrieve the data 320 from the first portion of the memory device and the copy of the data 320 from the second portion of the memory device 345 and transmit one of the data 320 or the copy of the data 320 to the controller 340 such that the controller 340 may communicate the data 320 or the copy of the data 320 to the host system 305.

In some examples, the memory device 345 may implement the redundancy techniques in tandem (e.g., in parallel, at a same or overlapping duration) with error correction and detection techniques. For example, upon receiving the write command for the data 320, the error control component 315 may generate parity 325 based on the data 320 and the memory device 345 may store the data 320 along with the parity 325 at the first portion of the memory device 345 and the copy of the data 320 along with a copy of the parity 325 at the second portion of the memory device 345. In some examples, the first portion of the memory device 345 and the second portion of the memory device 345 may share the error control component 315. Alternatively, the first portion of the memory device 345 and the second portion of the memory device 345 may be associated with different error control components 315. In such examples, the copy of the parity 325 may be generated by a second error control component 315 based on the copy of the data 320.

During a read operation for the data 320, the host system 305 may transmit read command for the data 320 to the controller 340 of the memory system 310 and the controller 340 may forward the read command for the data 320 to the memory device 345. In response to read command for the data 320, the error control component 315 of the memory device 345 may retrieve the data 320 and the parity 325 from the first portion of the memory device 345. Additionally, the error control component 315 may generate second parity 325 based on the data 320 and compare the second parity 325 to the parity 325 to check for errors in the data 320.

Similarly, in response to a read command for the data 320, the error control component 315 or the second error control component 315 of the memory device 345 may retrieve the copy of the data 320 and the copy of the parity 325 from the second portion of the memory device 345. Additionally, the error control component 315 or the second error control component 315 may generate third parity 325 based on the copy of the data 320 and compare the third parity 325 to the copy of the parity 325 to check for errors in the copy of the data 320.

The memory device 345 may determine which one of the data 320 or the copy of the data 320 to transmit to the controller 340 for transmission to the host system 305. In some examples, the memory device 345 may send the data 320 or the copy of the data 320 that does not have errors. For example, if the memory device 345 determines that the data 320 includes no errors and the copy of data 320 includes one or more errors, the memory device 345 may transmit the data 320 to the controller 340. Alternatively, if the memory device 345 determines that the data 320 includes one or more errors and the copy of data 320 includes no errors, the memory device 345 may transmit the copy of the data 320 to the controller 340 for transmission to the host system 305.

In another example, the memory device 345 may send the data 320 or the copy of the data 320 that has correctable errors. For example, if the memory device 345 determines that the data 320 includes the correctable error and the copy of data 320 includes the uncorrectable error, the memory device 345 may transmit the data 320 to the controller 340. Alternatively, if the memory device 345 determines that the data 320 includes the uncorrectable error and the copy of data 320 includes the correctable error, the memory device 345 may transmit the copy of the data 320 to the controller 340 for transmission to the host system 305.

In some examples, the memory device 345 may perform an initial parity check on the data 320 and the copy of the data 320 during the read operation. That is, the memory device 345 may compare the second parity 325 (e.g., the parity generated using the data 320 retrieved from the first portion) and the third parity (e.g., the parity generate using the copy of the data 320 retrieved from the second portion). If the second parity 325 and the third parity 325 match, the memory device 345 may determine that an error in the data 320 and the copy of the data 320 is unlikely (or does not exist) and may transmit one of the data 320 or the copy of the data 320 to the controller 340. That is, the memory device 345 may skip one or more operations related to error detection or error correction. Alternatively, if the second parity 325 and the third parity 325 do not match, the memory device 345 may determine that an error in the data 320 or the copy of the data 320 is likely (or does exist) and may perform the error correction or error detection operations to identify and potentially correct errors in the data 320 or the copy of the data 320.

In some examples, the memory device 345 may determine whether to implement the redundancy techniques (e.g., store the copy of the data 320 at the memory device 345). In one example, the memory device 345 may read a value of a parameter stored at a mode register of the memory system 310. The value of the parameter may be indicative of an operational mode for the memory device 345. For example, a first value of the parameter may indicate a first operational mode, and a second value of the parameter may indicate a second operational mode. The memory device 345 may read the mode register and operate according to the operational mode indicated by the value of the parameters stored at the mode register.

While operating according to the first operational mode, the memory device 345 may implement redundancy techniques and store the data 320 as well as the copy of the data 320 at the memory device 345 in response to the write command. Alternatively, while operating according to the second operational mode, the memory device 345 may not implement redundancy techniques and store the data 320 at the memory device 345. In some examples, the value of the parameter may be set by the host system 305 (e.g., via an MRW command).

Additionally, or alternatively, the memory device 345 may be configured with a reliable memory space. The reliable memory space may refer to a range of memory addresses that the memory device 345 may apply redundancy techniques to. As an example, the reliable memory space may include the bank 330-a. In such examples, the range of memory addresses for the reliable memory space may include memory addresses of the bank 330-a. In some examples, if the memory device 345 receives a write command that is included in the reliable memory space, the memory device 345 may implement redundancy techniques during a write operation corresponding to the write command.

For example, if the reliable memory space includes memory addresses of the bank 330-a, and the memory device 345 receives a write command to write the data 320 to the bank 330-a, the memory device 345 may write the data 320 to the first portion of the memory device 345 (e.g., the bank 330-a) and the copy of the data 320 to the second portion of the memory device 345 (e.g., the bank 330-b). Alternatively, if the reliable memory space includes memory addresses of the bank 330-a, and the memory device 345 receives a write command to write the data 320 to the bank 330-b, the memory device 345 may write the data 320 to the bank 330-b.

Additionally, or alternatively, the memory device 345 may determine whether to implement the redundancy techniques based on an access command received from the host system 305. For example, the memory device 345 may determine whether to implement the redundancy techniques during an access operation corresponding to the access command based on a type of access command, a type of data included in the access command, or both. Using the methods as described herein may allow the memory system 310 to increase the reliability of the data 320 when compared to other methods.

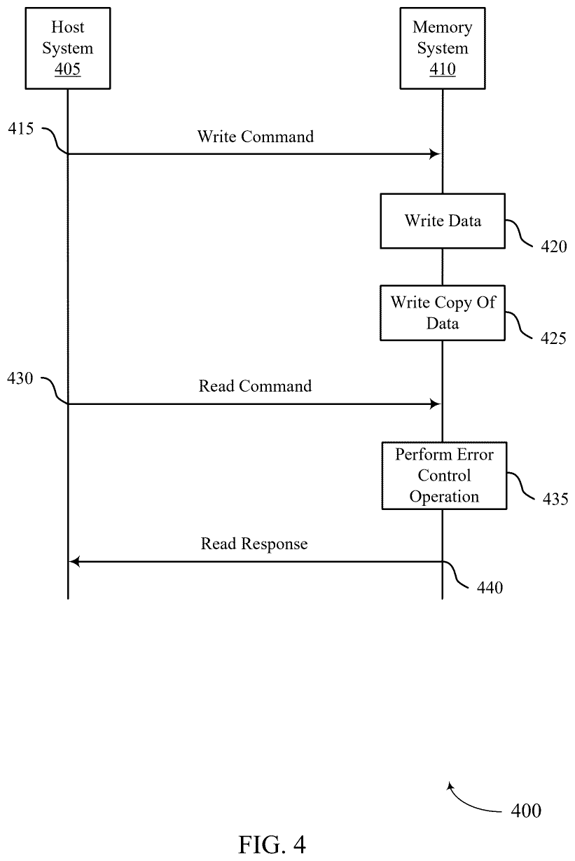

FIG. 4 shows an example of a process flow 400 that supports increased memory reliability via redundancy in accordance with examples as disclosed herein. In some examples, the process flow 400 may implement or be implemented by aspects of the system 100 or the system 300. For example, the process flow 400 may be implemented by a memory system 410 which may be an example of the memory system 110 or the memory system 310 as described with reference to FIGS. 1 and 3, respectively. Further, the process flow 400 may be implemented by a host system 405 which may be an example of the host system 105 or the host system 305 as described with reference to FIGS. 1 and 3, respectively. Alternative examples of the following may be implemented, where some steps are performed in a different order then described or are not performed at all. In some cases, steps may include additional features not mentioned below, or further steps may be added.

At 415, the host system 405 may transmit, to the memory system 410, a write command associated with data to be written to the memory system 410.

At 420, the memory system 410 may write the data to a first portion of the memory system based on receiving the write command at 415.

At 425, the memory system 410 may write a copy of the data to a second portion of the memory system based on the receiving the write command at 415. In some examples, the memory system 410 may write any quantity of copies of the data to the memory system 410. For example, the memory system 410 may additionally write a second copy of the data to a third portion of the memory system 410 in response to the write command received at 415. In some examples, the first portion of the memory system 410 may include a first memory bank of memory cells and the second portion of the memory system 410 may include a second memory bank of memory cells. In another example, the first portion of the memory system 410 and the second portion of the memory system 410 may correspond to a same row of memory cells.

In some examples, the memory system 410 may switch from a first operational mode to a second operation mode and write the copy of the data to the second portion of the memory system 410 based on switching from the first operational mode to the second operational mode. The memory system 410 may switch from the first operational mode to the second operational mode if the memory system 410 determines that a memory address associated with the write command is within a range of memory addresses associated with the second operational mode. In some examples, the memory system 410 may store an indication of the range of memory addresses associated with the second operational mode to a mode register of the memory system 410. Additionally, or alternatively, the memory system 410 may switch from the first operational mode to the second operational mode based on a type of the write command, a type of the data, or both.

In some examples, the memory system 410 may generate one or more parity bits associated with the data based on receiving the write command at 415. Further, the memory system 410 may write the one or more parity bits along with the data to the first portion of the memory system 410 and a copy of the one or more parity bits along with the copy of the data to the second portion of the memory system 410.

At 430, the host system 405 may transmit, to the memory system 410, a read command for the data. Upon receiving the read command for the data, the memory system 410 may read the data from the first portion of the memory system 410 and the copy of the data from the second portion of the memory system 410.

At 435, the memory system 410 may perform an error control operation on the data and the copy of the data. During the error control operation, the memory system may generate one or more first parity bits for the data based on reading the data from the first portion and generate one or more second parity bits for the copy of the data based on reading the copy of the data from the second portion.

At 440, the memory system 410 may transmit, to the host system 405, the data or the copy of the data based on performing the error control operation at 435. In some examples, during the error control operation, the memory system 410 may detect an error in the data. In such examples, the memory system 410 may discard the data based on detecting the error in the data and transmit the copy of the data based on discarding the data. In some examples, the memory system 410 may transmit the data or the copy of the data based on comparing the one or more first parity bits with the one or more second parity bits. Using the methods as described herein, the memory system 410 may increase reliability of the data compared to other methods.

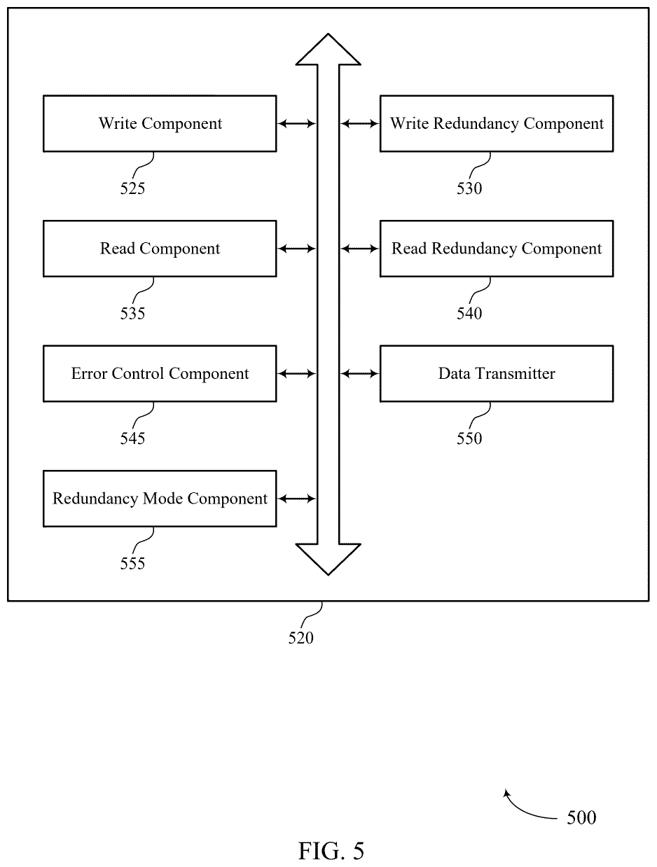

FIG. 5 shows a block diagram 500 of a memory system 520 that supports increased memory reliability via redundancy in accordance with examples as disclosed herein. The memory system 520 may be an example of aspects of a memory system as described with reference to FIGS. 1 through 4. The memory system 520, or various components thereof, may be an example of means for performing various aspects of increased memory reliability via redundancy as described herein. For example, the memory system 520 may include a write component 525, a write redundancy component 530, a read component 535, a read redundancy component 540, an error control component 545, a data transmitter 550, a redundancy mode component 555, or any combination thereof. Each of these components, or components of subcomponents thereof (e.g., one or more processors, one or more memories), may communicate, directly or indirectly, with one another (e.g., via one or more buses).

The write component 525 may be configured as or otherwise support a means for receiving a write command associated with data to be written to the memory system. The write redundancy component 530 may be configured as or otherwise support a means for writing the data to a first portion of the memory system and a copy of the data to a second portion of the memory system based at least in part on receiving the write command. The read component 535 may be configured as or otherwise support a means for receiving a read command for the data after writing the data and the copy of the data. The read redundancy component 540 may be configured as or otherwise support a means for reading the data from the first portion and the copy of the data from the second portion based at least in part on receiving the read command. The error control component 545 may be configured as or otherwise support a means for performing an error control operation on the data and the copy of the data after reading the data and the copy of the data. The data transmitter 550 may be configured as or otherwise support a means for transmitting the data or the copy of the data based at least in part on performing the error control operation.

In some examples, the write redundancy component 530 may be configured as or otherwise support a means for writing a second copy of the data to a third portion of the memory system based at least in part on receiving the write command.

In some examples, the error control component 545 may be configured as or otherwise support a means for generating one or more parity bits associated with the data based at least in part on receiving the write command. In some examples, the write component 525 may be configured as or otherwise support a means for writing the one or more parity bits and the data to the first portion of the memory system. In some examples, the write redundancy component 530 may be configured as or otherwise support a means for writing a copy of the one or more parity bits and the copy of the data to the second portion of the memory system.

In some examples, the error control component 545 may be configured as or otherwise support a means for detecting an error in the data based at least in part on performing the error control operation. In some examples, the error control component 545 may be configured as or otherwise support a means for discarding the data based at least in part on detecting the error in the data, where transmitting the data or the copy of the data includes transmitting the copy of the data based at least in part on discarding the data.

In some examples, the redundancy mode component 555 may be configured as or otherwise support a means for switching from a first mode of operation to a second mode of operation, where writing the copy of the data to the second portion of the memory system is based at least in part on switching from the first mode of operation to the second mode of operation.

In some examples, the redundancy mode component 555 may be configured as or otherwise support a means for determining that a memory address associated with the write command is within a range of memory addresses associated with the second mode of operation, where switching from the first mode of the operation to the second mode of operation is based at least in part on determining that the memory address associated with the write command is within the range of memory addresses associated with the second mode of operation.

In some examples, the redundancy mode component 555 may be configured as or otherwise support a means for storing an indication of the range of memory addresses associated with the second mode of operation to a mode register of the memory system. In some examples, switching from the first mode of operation to the second mode of operation is based at least in part on a type of the write command, a type of the data, or both.

In some examples, the error control component 545 may be configured as or otherwise support a means for generating one or more first parity bits for the data based at least in part on reading the data from the first portion of the memory system. In some examples, the error control component 545 may be configured as or otherwise support a means for generating one or more second parity bits for the copy of the data based at least in reading the copy of the data from the second portion of the memory system. In some examples, the data transmitter 550 may be configured as or otherwise support a means for transmitting the data or the copy of the data based at least in part on comparing the one or more first parity bits with the one or more second parity bits.

In some examples, the first portion of the memory system includes a first bank of memory cells of the memory system, and the second portion of the memory system includes a second bank of memory cells of the memory system. In some examples, the first portion of the memory system and the second portion of the memory system correspond to a same row of memory cells.

In some examples, the described functionality of the memory system 520, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 520, or various components thereof, may be implemented at least in part by instructions (e.g., stored in memory, non-transitory computer-readable medium) executable by such at least one processor.

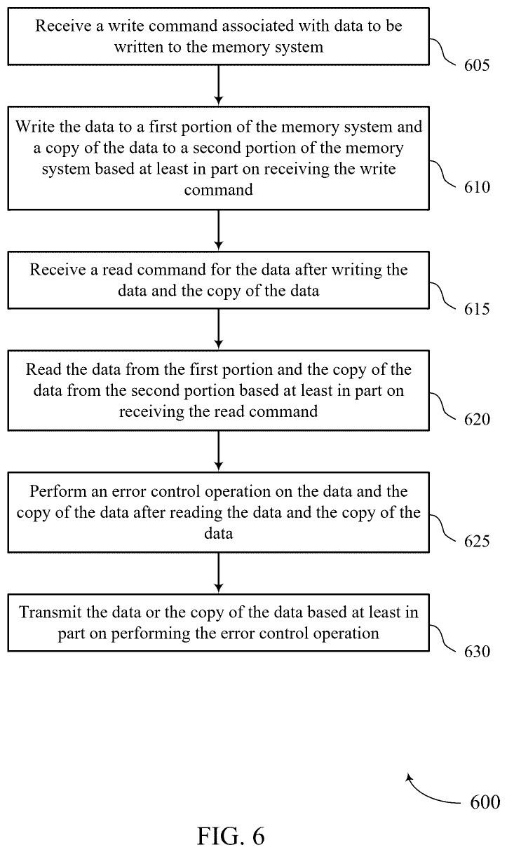

FIG. 6 shows a flowchart illustrating a method 600 that supports increased memory reliability via redundancy in accordance with examples as disclosed herein. The operations of method 600 may be implemented by a memory system or its components as described herein. For example, the operations of method 600 may be performed by a memory system as described with reference to FIGS. 1 through 5. In some examples, a memory system may execute a set of instructions to control the functional elements of the device to perform the described functions. Additionally, or alternatively, the memory system may perform aspects of the described functions using special-purpose hardware.

At 605, the method may include receiving a write command associated with data to be written to the memory system. In some examples, aspects of the operations of 605 may be performed by a write component 525 as described with reference to FIG. 5.

At 610, the method may include writing the data to a first portion of the memory system and a copy of the data to a second portion of the memory system based at least in part on receiving the write command. In some examples, aspects of the operations of 610 may be performed by a write redundancy component 530 as described with reference to FIG. 5.

At 615, the method may include receiving a read command for the data after writing the data and the copy of the data. In some examples, aspects of the operations of 615 may be performed by a read component 535 as described with reference to FIG. 5.

At 620, the method may include reading the data from the first portion and the copy of the data from the second portion based at least in part on receiving the read command. In some examples, aspects of the operations of 620 may be performed by a read redundancy component 540 as described with reference to FIG. 5.

At 625, the method may include performing an error control operation on the data and the copy of the data after reading the data and the copy of the data. In some examples, aspects of the operations of 625 may be performed by an error control component 545 as described with reference to FIG. 5.

At 630, the method may include transmitting the data or the copy of the data based at least in part on performing the error control operation. In some examples, aspects of the operations of 630 may be performed by a data transmitter 550 as described with reference to FIG. 5.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving a write command associated with data to be written to the memory system; writing the data to a first portion of the memory system and a copy of the data to a second portion of the memory system based at least in part on receiving the write command; receiving a read command for the data after writing the data and the copy of the data; reading the data from the first portion and the copy of the data from the second portion based at least in part on receiving the read command; performing an error control operation on the data and the copy of the data after reading the data and the copy of the data; and transmitting the data or the copy of the data based at least in part on performing the error control operation.

Aspect 2: The method, apparatus, or non-transitory computer-readable medium of aspect 1, further including operations, features, circuitry, logic, means, or instructions, or any combination thereof for writing a second copy of the data to a third portion of the memory system based at least in part on receiving the write command.

Aspect 3: The method, apparatus, or non-transitory computer-readable medium of any of aspects 1 through 2, further including operations, features, circuitry, logic, means, or instructions, or any combination thereof for generating one or more parity bits associated with the data based at least in part on receiving the write command; writing the one or more parity bits and the data to the first portion of the memory system; and writing a copy of the one or more parity bits and the copy of the data to the second portion of the memory system.

Aspect 4: The method, apparatus, or non-transitory computer-readable medium of any of aspects 1 through 3, further including operations, features, circuitry, logic, means, or instructions, or any combination thereof for detecting an error in the data based at least in part on performing the error control operation and discarding the data based at least in part on detecting the error in the data, where transmitting the data or the copy of the data includes transmitting the copy of the data based at least in part on discarding the data.

Aspect 5: The method, apparatus, or non-transitory computer-readable medium of any of aspects 1 through 4, further including operations, features, circuitry, logic, means, or instructions, or any combination thereof for switching from a first mode of operation to a second mode of operation, where writing the copy of the data to the second portion of the memory system is based at least in part on switching from the first mode of operation to the second mode of operation.

Aspect 6: The method, apparatus, or non-transitory computer-readable medium of aspect 5, further including operations, features, circuitry, logic, means, or instructions, or any combination thereof for determining that a memory address associated with the write command is within a range of memory addresses associated with the second mode of operation, where switching from the first mode of the operation to the second mode of operation is based at least in part on determining that the memory address associated with the write command is within the range of memory addresses associated with the second mode of operation.

Aspect 7: The method, apparatus, or non-transitory computer-readable medium of aspect 6, further including operations, features, circuitry, logic, means, or instructions, or any combination thereof for storing an indication of the range of memory addresses associated with the second mode of operation to a mode register of the memory system.

Aspect 8: The method, apparatus, or non-transitory computer-readable medium of any of aspects 5 through 7, where switching from the first mode of operation to the second mode of operation is based at least in part on a type of the write command, a type of the data, or both.

Aspect 9: The method, apparatus, or non-transitory computer-readable medium of any of aspects 1 through 8, further including operations, features, circuitry, logic, means, or instructions, or any combination thereof for generating one or more first parity bits for the data based at least in part on reading the data from the first portion of the memory system; generating one or more second parity bits for the copy of the data based at least in reading the copy of the data from the second portion of the memory system; and transmitting the data or the copy of the data based at least in part on comparing the one or more first parity bits with the one or more second parity bits.

Aspect 10: The method, apparatus, or non-transitory computer-readable medium of any of aspects 1 through 9, where the first portion of the memory system includes a first bank of memory cells of the memory system and the second portion of the memory system includes a second bank of memory cells of the memory system.

Aspect 11: The method, apparatus, or non-transitory computer-readable medium of any of aspects 1 through 10, where the first portion of the memory system and the second portion of the memory system correspond to a same row of memory cells.

It should be noted that the aspects described herein describe possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (e.g., in conductive contact with, connected with, coupled with) one another if there is any electrical path (e.g., conductive path) between the components that can, at any time, support the flow of signals (e.g., charge, current, voltage) between the components. A conductive path between components that are in electronic communication with each other (e.g., in conductive contact with, connected with, coupled with) may be an open circuit or a closed circuit based on the operation of the device that includes the connected components. A conductive path between connected components may be a direct conductive path between the components or may be an indirect conductive path that includes intermediate components, such as switches, transistors, or other components. In some examples, the flow of signals between the connected components may be interrupted for a time, for example, using one or more intermediate components such as switches or transistors.

A switching component (e.g., a transistor) discussed herein may be a field-effect transistor (FET), and may include a source (e.g., a source terminal), a drain (e.g., a drain terminal), a channel between the source and drain, and a gate (e.g., a gate terminal). A conductivity of the channel may be controlled (e.g., modulated) by applying a voltage to the gate which, in some examples, may result in the channel becoming conductive. A switching component may be an example of an n-type FET or a p-type FET.

The description set forth herein, in connection with the appended drawings, describes example configurations and does not represent all the examples that may be implemented or that are within the scope of the claims. The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Similar components may be distinguished by following the reference label by one or more dashes and additional labeling that distinguishes among the similar components. If just the first reference label is used in the specification, the description is applicable to any one of the similar components having the same first reference label irrespective of the additional reference labels.

The functions described herein may be implemented in hardware, software executed by a processing system (e.g., one or more processors, one or more controllers, control circuitry processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The descriptions and drawings are provided to enable a person having ordinary skill in the art to make or use the disclosure. Various modifications to the disclosure will be apparent to the person having ordinary skill in the art, and the techniques disclosed herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
receive a write command associated with data to be written to the memory system;
write the data to a first portion of the memory system and a copy of the data to a second portion of the memory system based at least in part on receiving the write command;
receive a read command for the data after writing the data and the copy of the data;
read the data from the first portion and the copy of the data from the second portion based at least in part on receiving the read command;
perform an error control operation on the data and the copy of the data after reading the data and the copy of the data; and
transmit the data or the copy of the data based at least in part on performing the error control operation.

2. The memory system of claim 1, wherein the processing circuitry is further configured to cause the memory system to:
write a second copy of the data to a third portion of the memory system based at least in part on receiving the write command.

3. The memory system of claim 1, wherein the processing circuitry is further configured to cause the memory system to:
generate one or more parity bits associated with the data based at least in part on receiving the write command;
write the one or more parity bits and the data to the first portion of the memory system; and
write a copy of the one or more parity bits and the copy of the data to the second portion of the memory system.

4. The memory system of claim 1, wherein the processing circuitry is further configured to cause the memory system to:
detect an error in the data based at least in part on performing the error control operation; and
discard the data based at least in part on detecting the error in the data, wherein, to transmit the data or the copy of the data, the processing circuitry is configured to cause the memory system to:
transmit the copy of the data based at least in part on discarding the data.

5. The memory system of claim 1, wherein the processing circuitry is further configured to cause the memory system to:
switch from a first mode of operation to a second mode of operation, wherein the processing circuitry is configured to cause the memory system to write the copy of the data to the second portion of the memory system based at least in part on switching from the first mode of operation to the second mode of operation.

6. The memory system of claim 5, wherein the processing circuitry is further configured to cause the memory system to:
determine that a memory address associated with the write command is within a range of memory addresses associated with the second mode of operation, wherein the processing circuitry is configured to cause the memory system to switch from the first mode of the operation to the second mode of operation based at least in part on determining that the memory address associated with the write command is within the range of memory addresses associated with the second mode of operation.

7. The memory system of claim 6, wherein the processing circuitry is further configured to cause the memory system to:
store an indication of the range of memory addresses associated with the second mode of operation to a mode register of the memory system.

8. The memory system of claim 5, wherein switching from the first mode of operation to the second mode of operation is based at least in part on a type of the write command, a type of the data, or both.

9. The memory system of claim 1, wherein the processing circuitry is further configured to cause the memory system to:
generate one or more first parity bits for the data based at least in part on reading the data from the first portion of the memory system;
generate one or more second parity bits for the copy of the data based at least in reading the copy of the data from the second portion of the memory system; and
transmit the data or the copy of the data based at least in part on comparing the one or more first parity bits with the one or more second parity bits.

10. The memory system of claim 1, wherein the first portion of the memory system comprises a first bank of memory cells of the memory system and the second portion of the memory system comprises a second bank of memory cells of the memory system.

11. The memory system of claim 1, wherein the first portion of the memory system and the second portion of the memory system correspond to a same row of memory cells.

12. A method by a memory system, comprising:
receiving a write command associated with data to be written to the memory system;
writing the data to a first portion of the memory system and a copy of the data to a second portion of the memory system based at least in part on receiving the write command;
receiving a read command for the data after writing the data and the copy of the data;
reading the data from the first portion and the copy of the data from the second portion based at least in part on receiving the read command;
performing an error control operation on the data and the copy of the data after reading the data and the copy of the data; and
transmitting the data or the copy of the data based at least in part on performing the error control operation.

13. The method of claim 12, further comprising:
writing a second copy of the data to a third portion of the memory system based at least in part on receiving the write command.

14. The method of claim 12, further comprising:
generating one or more parity bits associated with the data based at least in part on receiving the write command;
writing the one or more parity bits and the data to the first portion of the memory system; and
writing a copy of the one or more parity bits and the copy of the data to the second portion of the memory system.

15. The method of claim 12, further comprising:
detecting an error in the data based at least in part on performing the error control operation; and
discarding the data based at least in part on detecting the error in the data, wherein transmitting the data or the copy of the data comprises:
transmitting the copy of the data based at least in part on discarding the data.

16. The method of claim 12, further comprising:
switching from a first mode of operation to a second mode of operation, wherein writing the copy of the data to the second portion of the memory system is based at least in part on switching from the first mode of operation to the second mode of operation.

17. The method of claim 16, further comprising:
determining that a memory address associated with the write command is within a range of memory addresses associated with the second mode of operation, wherein switching from the first mode of the operation to the second mode of operation is based at least in part on determining that the memory address associated with the write command is within the range of memory addresses associated with the second mode of operation.

18. The method of claim 17, further comprising:
storing an indication of the range of memory addresses associated with the second mode of operation to a mode register of the memory system.

19. The method of claim 16, wherein switching from the first mode of operation to the second mode of operation is based at least in part on a type of the write command, a type of the data, or both.

20. The method of claim 12, further comprising:
generating one or more first parity bits for the data based at least in part on reading the data from the first portion of the memory system;
generating one or more second parity bits for the copy of the data based at least in reading the copy of the data from the second portion of the memory system; and
transmitting the data or the copy of the data based at least in part on comparing the one or more first parity bits with the one or more second parity bits.

21. A non-transitory computer-readable medium storing code, the code comprising instructions executable by one or more processors to:
receive a write command associated with data to be written to a memory system;
write the data to a first portion of the memory system and a copy of the data to a second portion of the memory system based at least in part on receiving the write command;
receive a read command for the data after writing the data and the copy of the data;
read the data from the first portion and the copy of the data from the second portion based at least in part on receiving the read command;
perform an error control operation on the data and the copy of the data after reading the data and the copy of the data; and
transmit the data or the copy of the data based at least in part on performing the error control operation.

22. The non-transitory computer-readable medium of claim 21, wherein the instructions are further executable by the one or more processors to:
write a second copy of the data to a third portion of the memory system based at least in part on receiving the write command.
